(19) United States
(12) Patent Application Publication
(10) Pub. No.: US 2012/0066140 A1
(43) Pub. Date: Mar. 15, 2012

(54) METHOD AND APPARATUS FOR MONITORING ADHERENCE TO PRESCRIBED REGIMENS

(75) Inventors: Jamin Hegeman, San Francisco, CA (US); Carrie Chan, San Francisco, CA (US); Daniel Gazineu, Porto Alegre/RS (BR); Wilson Silva Prata, Manaus/AM (BR); Rita Parada, San Francisco, CA (US)

(73) Assignee: Nokia Corporation, Espoo (FI)

(21) Appl. No.: 12/881,853

(22) Filed: Sep. 14, 2010

(51) Int. Cl. G06F 15/16; G06Q 99/00

(52) U.S. Cl. 705/319; 709/204

(57) ABSTRACT

An approach is provided for monitoring adherence to prescribed regimens. A social service platform receives an input for specifying a schedule associated with a user. Next, the social service platform determines to create at least one social network group, the members of the social network group including, at least in part, the user and one or more other users. Then, the social service platform determines to establish one or more communication sessions among devices corresponding to at least some of the members based, at least in part, on the schedule.

### BACKGROUND

Service providers and device manufacturers (e.g., wireless, cellular, etc.) are continually challenged to deliver value and convenience to consumers by, for example, providing compelling network services. One area of development has been the treatment of diseases. For example, recent advances in the pharmaceutical treatment for human immunodeficiency virus/acquired immune deficiency syndrome (HIV/AIDS) have significantly increased the potential for better health and a longer lifespan for those living with the disease. However, for the medications to work effectively, patients generally adhere to prescribed regimens with little or no deviation. If the medications are taken improperly (e.g., missing or modifying doses), the medications may fail to prevent viral replication. Consequently, some HIV strains may develop a resistance or become immune to the medications. In addition, the disease itself may become less treatable as this problem occurs on a population scale. Unfortunately, one major obstacle to treating patients with potentially serious illnesses is that they may not take their medications due to a number of reasons, including the social stigma associated with the disease.

### SOME EXAMPLE EMBODIMENTS

Therefore, there is a need for an approach for efficiently monitoring adherence to prescribed regimens (e.g., treatment regimens or schedules associated with treating an illness).

According to one embodiment, a method comprises receiving an input for specifying a schedule associated with a user. The method also comprises determining to create at least one social network group, the members of the social network group including, at least in part, the user and one or more other users. The method further comprises determining to establish one or more communication sessions among devices corresponding to at least some of the members based, at least in part, on the schedule.

According to another embodiment, an apparatus comprises at least one processor, and at least one memory including computer program code, the at least one memory and the computer program code configured to, with the at least one processor, cause, at least in part, the apparatus to receive an input for specifying a schedule associated with a user. The apparatus is also caused to determine to create at least one social network group, the members of the social network group including, at least in part, the user and one or more other users. The apparatus is further caused to determine to establish one or more communication sessions among devices corresponding to at least some of the members based, at least in part, on the schedule.

According to another embodiment, a computer-readable storage medium carries one or more sequences of one or more instructions which, when executed by one or more processors, cause, at least in part, an apparatus to receive an input for specifying a schedule associated with a user. The apparatus is also caused to determine to create at least one social network group, the members of the social network group including, at least in part, the user and one or more other users. The apparatus is further caused to determine to establish one or more communication sessions among devices corresponding to at least some of the members based, at least in part, on the schedule.

According to another embodiment, an apparatus comprises means for receiving an input for specifying a schedule associated with a user. The apparatus also comprises means for determining to create at least one social network group, the members of the social network group including, at least in part, the user and one or more other users. The apparatus further comprises means for determining to establish one or more communication sessions among devices corresponding to at least some of the members based, at least in part, on the schedule.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of monitoring adherence to prescribed regimens, according to one embodiment;

FIG. 2 is a diagram of the components of a social service platform, according to one embodiment;

FIG. 3 is a flowchart of a process for monitoring adherence to prescribed regimens, according to one embodiment;

FIGS. 4A-4B are diagrams of user interfaces providing notifications to a user, according to various embodiments;

FIGS. 5A-5D are diagrams of user interfaces demonstrating the use of reports to encourage adherence to prescribed regimens, according to various embodiments;

FIGS. 6A-6C are diagrams of user interfaces demonstrating the use of group reports to encourage group adherence to prescribed regimens, according to various embodiments;

FIGS. 7A-7D are diagrams of user interfaces illustrating a process of joining a social network group, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for monitoring adherence to prescribed regimens are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are discussed with respect to patients under treatment for HIV/AIDS, it is contemplated that the approach described herein is applicable to any illness (e.g., physical and/or psychological) associated with a prescribed course of treatment. As used herein, the term “treatment provider” refers to one or more doctors, nurses, caretakers, other health-related persons or institutions, and/or the like.

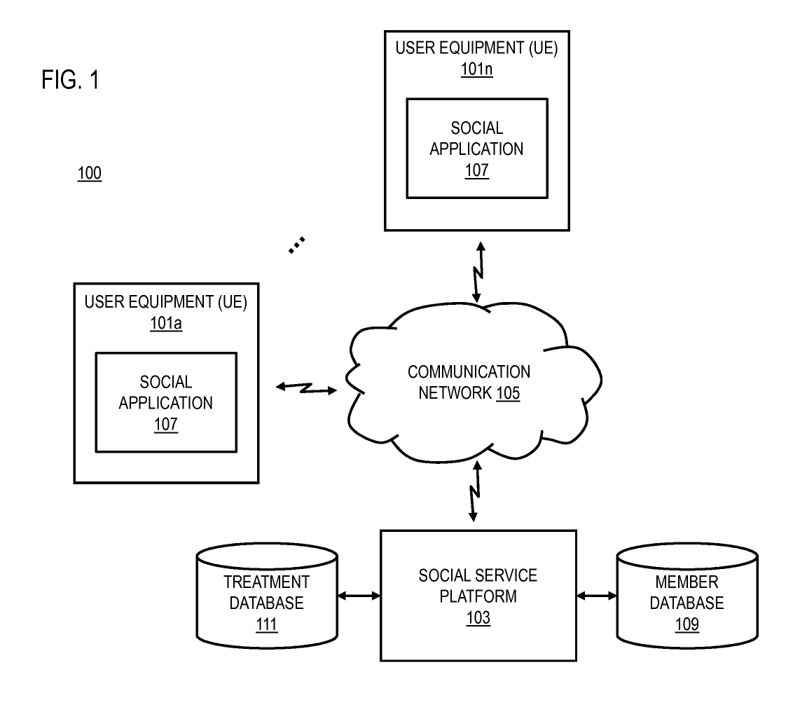

FIG. 1 is a diagram of a system capable of monitoring adherence to prescribed regimens, according to one embodiment. As previously mentioned, HIV/AIDS medications greatly increased the potential for those living with the disease to have a healthier, longer life when the medications are taken properly (e.g., adherence to prescribed regimens with little or no deviation). However, a major obstacle to treating the disease is that patients may not take their medications due to a variety of factors, such as poor memory, personal or work-related responsibilities, hopelessness or depression, efforts to avoid side effects associated with treatment, inadequate patient knowledge, or the complexity of prescribed regimens. Moreover, the lack of adherence to treatment regimens has also been linked to the social stigma commonly associated with the disease. When these medications are taken improperly (e.g., missing or modifying doses), some HIV strains may subsequently develop a resistance or become immune to the medications. As this problem occurs on a population scale, the disease may become less treatable. For example, missing one or two doses per month may promote strains of HIV that are resistant to medications. As a result, the treatment options available may become limited to others who may later become infected with these resistant strains. Such consequences may occur in circumstances where the patient is newly infected with the disease or where the patient already carries strains of the virus. Nevertheless, despite the risks, poor adherence to treatment is common among those living with HIV/AIDS. In addition, it is noted that the treatment adherence problem and/or the risks involved with poor treatment adherence also exists for certain disorders and other diseases (e.g., other sexually transmitted diseases, tuberculosis (TB), etc.), especially those that may involve a social stigma.

To address this problem, a system 100 of FIG. 1 introduces the capability to monitor adherence to prescribed regimens through the use of a social network accessible via corresponding one or more social network applications and/or services. More specifically, the system 100 creates or otherwise provides access to the social network and then creates links between the social network and one or more schedules associated with a particular user and/or other members of the social network. In one embodiment, the schedules relate to treatment regimens for an illness such as HIV/AIDS. In this way, the system 100 can generate reminder notifications and/or establish communications for discussion related to the schedule. In one embodiment, the notifications may include queries to determine adherence to a corresponding schedule. Based on these responses, the system 100 can generate reports on adherence rates for the user, other members of the social network, and/or for the social network group as a whole. In one embodiment, the social network (or social networks) may comprise one or more social network groups, wherein the members of a particular social network group may include a patient, the patient's family members and/or relatives, other patients, treatment providers, etc. As such, the patient is provided with an environment (e.g., the social network, the social network group, etc.) that may help or encourage the patient abide by his/her prescribed schedule.

In one sample use case, a social network group may include the patient, the patient's doctor, and other patients having a schedule substantially similar to the patient's schedule. Because all the members of the social network group, including the doctor, may understand the symptoms, the side effects, and other issues associated with the disease, the social network group environment may open the doors for communication between the members with respect to the problems or worries that they may be having. In this way, the system 100 is more likely to establish communication sessions between or among members with knowledge and/or experience with the linked treatment regimen. As a result, the social stigma associated with the disease that may exist outside the social network group may be greatly alleviated at least in the social network group environment. In this scenario, the doctor may also provide the patient with reminders to take certain medications based on the patient's schedule. By way of example, the doctor may initiate a reminder by specifying, for instance, a schedule of treatment including a date/time associated with one or more items of the treatment. The system 100 then schedules reminder notifications to the user and/or the social network based on the specified schedule. Similarly, the system 100 may generate and transmit notifications to the other patients or members of the social network group so that the other patients may initiate communications (e.g., via text messaging, instant messaging, e-mail, etc.) available over the social network to remind the patient to take certain medications based on the patient's schedule. In this way, the system 100 can establish communication sessions among members of the social network group to possibly prevent the patient from forgetting to take scheduled medications, from taking the wrong medications, and/or from taking an inaccurate dosage.

Furthermore, in another embodiment, the members of the social network group may provide the patient with encouragement and support in addition to reminders. If, for instance, the patient has continued to follow prescribed regimens (e.g., based on monitoring by the system 100), the system 100 may notify members of the social network group of the patient's adherence. The other patients having a schedule that is substantially similar to the patient's schedule may subsequently send the patient a message over the system 100 to reinforce compliance with the patient's schedule, such as “Congratulations! I knew you could do it!”, “Way to go!”, etc., so that the patient may continue to adhere to the prescribed schedule. On the other hand, if the patient has not yet taken a particular medication as scheduled, the system 100 may notify members of the social network group that the patient has not yet taken the medication as required. As a result, the other members may send the patient a message over the system 100 to urge adherence to the patient's schedule, such as “I just took my medication, you can take yours!”, “Come on! You and I need to stick to our schedules!”, etc., so that the patient may be persuaded to abide by the prescribed schedule.

More specifically, the system 100 may receive an input for specifying a schedule associated with a user, such as a patient. The input specifying the schedule may be received from or transmitted by one or more treatment providers (e.g., doctors, nurses, caretakers, other health-related persons or institutions, and/or the like.). As previously noted, the schedule may be associated with a treatment regimen for the user. The system 100 may then create a social network group, wherein the members of the social network group include the user and one or more other users. By way of example, the user may include the patient and the one or more other users may include the one or more treatment providers. The system 100 may subsequently or simultaneously add other users, such as other patients of the one or more treatment providers, to the social network group. It is noted that the other users may be added automatically by the system 100 or upon request, for instance, by the one or more treatment providers. Further, the system 100 may establish one or more communication sessions among devices corresponding to some of the members based on the schedule. The one or more communication sessions may include a text, voice, and/or video session for discussing the treatment regimen, adherence to the treatment regimen, and the like. It is also contemplated that the social network can also establish communication sessions to discuss any other topic of interest to the group including topics unrelated to the treatment regimen.

As shown in FIG. 1, the system 100 comprises a user equipment (UE) 101 or multiple UEs 101a-101n (or UEs 101) having connectivity to a social service platform 103 via a communication network 105. A UE 101 may include or have access to a social application 107, which may be a program, application, or the like that enables the UE 101 to access and/or interact with a social network created and/or maintained, for instance, by the social service platform 103 or other services provided by the social service platform 103. As part of the social network, the social service platform 103 may create and/or maintain one or more social network groups which may include, as members, users of the UEs 101a-101n. As such, the social service platform 103 may include or be connected to a member database 109 in order to access or store data or information with respect to the members (e.g., name, date of birth, gender, patient id, schedule, social network group associations, etc.). The social service platform 103 may also include or be connected to a treatment database 111 in order to access or store data or information with respect to treatments (e.g., available or potential treatments, schedules, users associated with the treatments or schedules, etc.).

By way of example, a doctor or other treatment provider may use a UE 101 to access the services of the social service platform 103 by, for instance, logging into the social service platform 103 with a valid username and password. Thereafter, the doctor may access the member database 109 and the treatment database 111 to determine the appropriate treatment or treatment regimen for the doctor's patients. The social service platform 103 may then receive an input, from the doctor, for specifying a schedule associated with a patient of the doctor. Subsequently, the social service platform 103 may create a social network group which includes the patient, other patients, and the doctor. The social service platform 103 may further establish one or more communication sessions among devices (e.g., UEs 101a-101n) corresponding to some of the members of the social network group based on the schedule. As previously discussed, the other patients of the social network group may comprise of other patients having a schedule that is substantially similar to the patient's schedule. The patient may want to communicate with others going through the same experience (e.g., sharing the same schedule, having the same symptoms, etc.) for a number of reasons, such as loneliness, depression, anxiety about side effects or symptoms, etc. Thus, the social service platform 103 may initiate, either automatically or upon request, a text, voice, and/or video session between two users via their respective UE 101. Examples of a text, voice, and/or video session include SMS, instant messaging, voice/video chats, and/or the like.

Further, the social application 107 may handle various communication operations using any form of communications available at the UE 101. For example, the social application 107 may manage incoming or outgoing communications via the UE 101, and display such communications as they are received or processed. In certain embodiments, the social application may also provide visualization (e.g. graphical user interface) to allow a user to control communications or share data over the communication network 105 using any available form of communications. For example, the social application 107 may include an option to select communications with the UEs 101a-101n in order to share data. Further, the social application 107 may include interfaces that allow the user to communicate with any Internet-based websites or to use e-mail services via the social service platform 103.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In another embodiment, one or more notifications may be generated based on the schedule. In one sample use case, a doctor may prescribe a new schedule to a patient to replace or modify the patient's existing schedule. As a result, the one or more notifications that are generated may include a message indicating that the patient's schedule has changed. In another sample use case, a new social group may be created for the patient based on the patient's new schedule to replace or supplement the patient's existing social groups. Accordingly, the one or more notifications may also include a message that a new social group has been created for the patient. Thereafter, the one or more notifications may be transmitted to the patient, one or more other users, or a combination thereof via, for instance, the UE 101 of the respective users (e.g., the patient, the one or more other users, etc.).

In another embodiment, the one or more notifications may include a query regarding compliance with one or more items of the schedule. The patient, for instance, may receive a query asking whether the patient has taken certain medications as scheduled. As such, the patient may indicate either that he has taken or that he has not yet taken the medications. In a further embodiment, the patient's response (or responses) may cause a notification to be transmitted to the patient and/or to the one or more other users. By way of example, the notification transmitted to the one or more other users, as a result of the patient's response, may include an announcement that the patient has either taken or not yet taken certain medications as schedule. As discussed above, the one or more other users may thereafter, depending on the patient's response or responses to the query, send the patient messages reinforcing compliance with the patient's schedule or messages urging adherence to the patient's schedule. If, for instance, the patient indicated that the patient has taken the medications as schedule, the one or more other users may send messages like “Congratulations! I knew you could do it!”, “Way to go!”, etc. However, if the patient indicated that the patient has not yet taken the medications as schedule, the one or more other users may send messages like “I just took my medication, you can take yours!”, “Come on! You and I need to stick to our schedules!”, etc. By way of another example, the notification transmitted to the patient, as a result of the patient's response, may include words of reinforcement or words of encouragement. If, for instance, the patient indicated that the medications were taken as prescribed, the notification to the patient may include messages reinforcing the patient's compliance. However, if the patient indicated that the medications were not taken, the notification to the patient may include messages urging the patient's adherence to the prescribed regimens.

In another embodiment, the patient's treatment adherence rate may be determined based on the patient's one or more responses to the query. The adherence rate may also be determined based on the patient's one or more responses to one or more past queries. For example, the query may include one or more questions with regard to the medications that the patient is scheduled to take each day. As such, the adherence rate may be determined based on the patient's responses to the one or more questions for that day, that week, that month, that year, etc. If, for instance, the patient indicated that the patient has taken all the medications scheduled for that day, the adherence rate for that day would be 100%. On the other hand, if the patient has indicated in past queries that he has not taken certain medications as scheduled, the patient's adherence rate for that week, that month, that year, etc., may not be as high. In a further embodiment, the patient's treatment adherence rate may also depend on a particular threshold period, for instance, to ensure that the adherence rate is accurate. For example, the user may not be able to state that the medications were taken as prescribed after a certain amount of time has passed since the prescribed medication time.

In another embodiment, a report of the patient's treatment adherence rate, of other treatment adherence rates associated with the one or more other users, or a combination thereof may be generated. The report (or reports) may subsequently be viewed by the patient and/or by the one or more other users via, for instance, their respective UE 101. It may be important for patients to see a report of their own adherence rate because they may not remember how many scheduled medications they did not take or if they previously took an incorrect dosage. The report itself may also be a reminder that they should pay more attention, for instance, to their prescribed treatment regimen if the report indicates that their treatment adherence rate is not as high as it should be.

In addition, it may be equally important for the patient to see a report of the adherence rates of the one or more other users and/or for the one or more other users to see a report of the patient's adherence rate. By way of example, if the patient sees that the one or more other users' adherence rate is higher than the patient's adherence rate, the patient may want to increase his/her own adherence rate by following his/her schedule more strictly. Similarly, the one or more other users may want to increase their own adherence rate by following their respective schedule more strictly if they see that the patient's adherence rate is higher than their respective adherence rate. On the other hand, reports that illustrate the adherence rates of others may also open the door for words of reinforcement or words of encouragement, depending on how a particular adherence rate may be viewed by others (e.g., high, sufficient, low, etc.). In other words, the reports are another incentive for the members of the social network group to communicate with each other and to encourage adherence to prescribe regimens. Similarly, reports that describes the treatment adherence rate of the social network group as a whole may also provide an incentive for the members to communicate with each other and to encourage adherence to prescribe regimens (e.g., a high group adherence rate may be viewed as a team effort).

In another embodiment, one or more actions associated with the schedule may be triggered. The one or more actions may include initiating communications with a treatment provider, scheduling an appointment with a treatment provider, initiating one or more transactions to obtain one or more treatment items, or a combination thereof. In addition, the one or more actions may also be triggered automatically or upon request. For example, a patient and/or a patient's doctor may initiate or request a communication session between the patient and the doctor. On the other hand, an appointment with the doctor may be scheduled automatically if the patient's treatment adherence rate falls below a predetermined level. As such, the doctor may also confirm the appointment with the patient or cancel the appointment if, after speaking with the patient, determines that the appointment is not necessary.

In another embodiment, the one or more communication sessions may be parsed. In a further embodiment, information related to the schedule, a condition of the user, respective conditions of the one or more other users, or a combination thereof may be determined based on the parsing. As previously mentioned, the one or more communication sessions may include a text, voice, and/or video session. In one sample use case, a patient may be carrying text conversations with one or more other patients using texting functions (e.g., SMS, instant messaging, etc.) available on the patient's UE 101. During the conversation, the patient might express worry over the side effects of a new medication recently added to the patient's schedule. When the text conversations are parsed (e.g., in real-time, during the conversation, after the conversation, etc.), it may be determined that the patient has a question relating to the side effects of the new medication. As a result, a search may be performed with respect to the potential side effects (e.g., a search through the treatment database 111, a treatment provider database (not shown), the Internet, etc.). Subsequently, the results of the search may be provided to the patient, for instance, in the form of a text. In another sample use case, a patient may be carrying a phone conversation with the patient's doctor using the patient's UE 101. The doctor may ask the patient a series of questions with regard to whether the patient has taken or not taken certain medications. The phone conversation may be parsed using voice analysis software to determine the patient's treatment adherence rate based on the doctor's questions and the patient's answers to the questions. It is also noted that voice analysis may also be used to determine the patient's treatment adherence rate based on how the patient answered the doctor's questions (e.g., a voice stress analysis to determine the truthfulness of the patient's answers).

In another embodiment, as mentioned above, at least some of the one or more other users may be selected based on whether the at least some of the one or more other users have respective other schedules that are substantially similar to the patient's schedule. Because patients may be more comfortable or at ease in an environment with others that are going through the same or similar circumstances, they may be more inclined to open up, to discuss problems, to be encouraged, etc., in such an setting. Patients having schedules that are substantially similar to each other's schedule may experience the same side effects, the same symptoms, the same social stigma, etc., as each other. Therefore, a social network group comprising of at least some members having substantially similar schedules may encourage those members to adhere, for instance, to their prescribed treatment regimens.

By way of example, the UE 101 and the social service platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

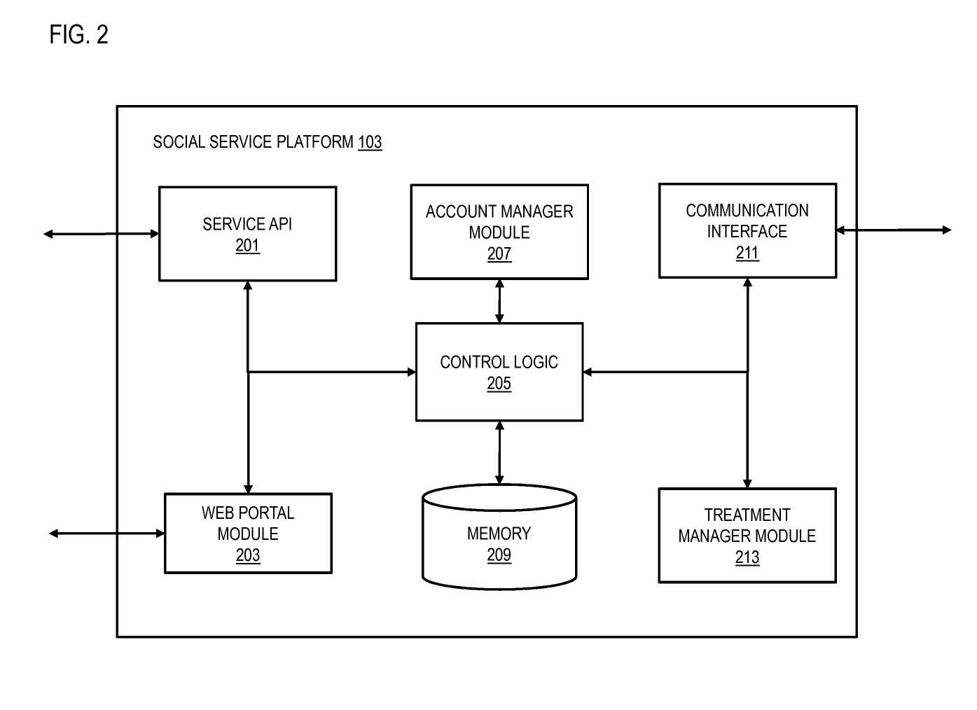

FIG. 2 is a diagram of the components of a social service platform, according to one embodiment. By way of example, the social service platform 103 includes one or more components for providing encouragement in adhering to prescribed regimens. It is contemplated that the functions of these components may be combined in one or more components or performed by other components of equivalent functionality. In this embodiment, the social service platform 103 includes a service API 201, a web portal module 203, control logic 205, an account manager module 207, memory 209, a communication interface 211, and a treatment manager module 213.

The control logic 205 can be utilized in controlling the execution of modules and interfaces of the social service platform 103. The program modules can be stored in the memory 209 while executing. A communication interface 211 can be utilized to interact with UEs 101 (e.g., via a communication network 105). Further, the control logic 205 may utilize the service API 201 (e.g., in conjunction with the communication interface 211) to interact with social applications 107 and/or other applications, platforms, and/or the like.

The communication interface 211 may include multiple means of communication. For example, the communication interface 211 may be able to communicate over SMS, internet protocol, instant messaging, voice sessions (e.g., via a phone network), or other types of communication. The communication interface 211 can be used by the control logic 205 to communicate with the UEs 101a-101n, and other devices. In some examples, the communication interface 211 is used to transmit and receive information using protocols and methods associated with the service API 201.

By way of example, the account manager module 207 may be utilized to handle users of the social network as well as any data associated with the users. As such, the account manager module 207 may validate user logins, manage user information (e.g., name, date of birth, gender, patient id, schedule, social network group associations, etc.), generate notifications to send to the UEs 101 via the communication interface 211 and/or API 201, etc. Moreover, the account manager module 207 may coordinate with a web portal module 203 to facilitate access to the social service platform 103. As such, the web portal module 203 can generate a webpage and/or a web access API to allow UEs 101 to access the social service platform 103.

In addition, the treatment manager module 213 may be utilized to manage and customize schedules. Although some schedules may be predefined, treatment providers, such as doctors, often must provide patients with a unique schedule to fit their needs. As such, the treatment manager module 213 may provide, for instance, a doctor with the tools to create schedules for their patients. For example, the treatment manager module 213 may provide the doctor with information regarding medications or other treatments available at the treatment database 111, the current and/or past schedules associated with particular patients, suggestions for schedules based on a patient's symptoms and/or other health information, etc. Further, the treatment manager module 213 may also coordinate with the web portal module 203 to facilitate access to the social service platform 103, for instance, by generating a webpage and/or a web access API specifically for treatment providers.

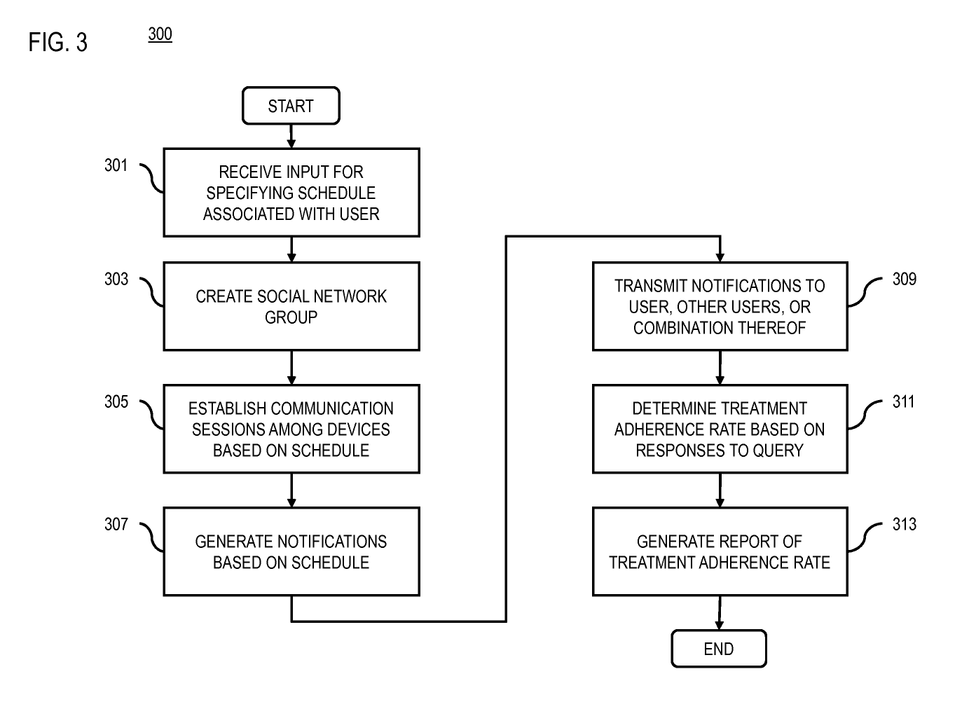

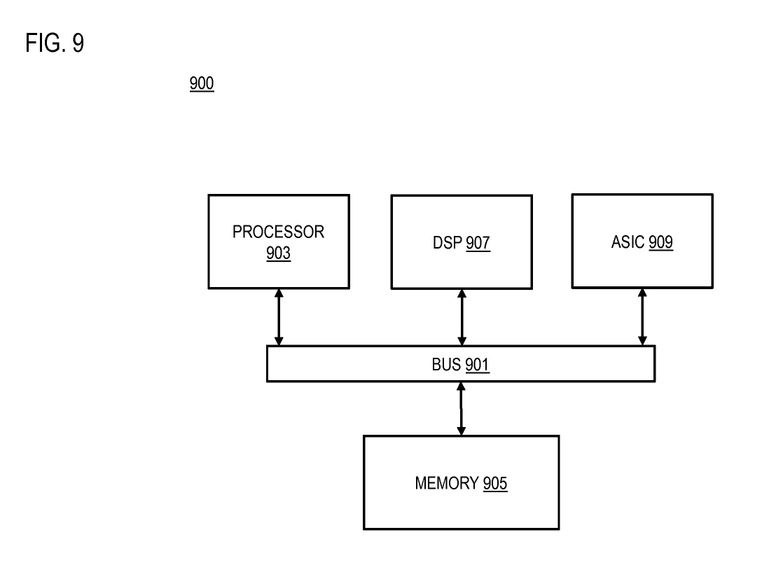

FIG. 3 is a flowchart of a process for monitoring adherence to prescribed regimens, according to one embodiment. In one embodiment, the control logic 205 and/or other components of the social service platform 103 performs the process 300 and is implemented in, for instance, a chip set including a processor and a memory as shown in FIG. 9. As such, the control logic 205 can provide means for accomplishing various parts of the process 300 as well as means for accomplishing other processes in conjunction with other components of the social service platform 103.

In step 301, the control logic 205 receives an input, e.g., from a treatment provider, for specifying a schedule associated with a user, such as a patient associated with the treatment provider. The control logic 205 may then, as in step 303, determine to create at least one social network group, the members of the social network group including, at least in part, the user and one or more other users. As mentioned above, the user may include the patient and the one or more other users may include the one or more treatment providers. Additional other users, such as other patients of the one or more treatment providers, may also be added to the social network group simultaneously or at a later time. The control logic may further, as in step 305, determine to establish one or more communication sessions among devices, e.g., the UEs 101a-101n, corresponding to at least some of the members based, at least in part, on the schedule. Such communication sessions may include a text, voice, and/or video sessions between users via their respective UE 101. Examples of a text, voice, and/or video session include SMS, instant messaging, voice/video chats, and/or the like.

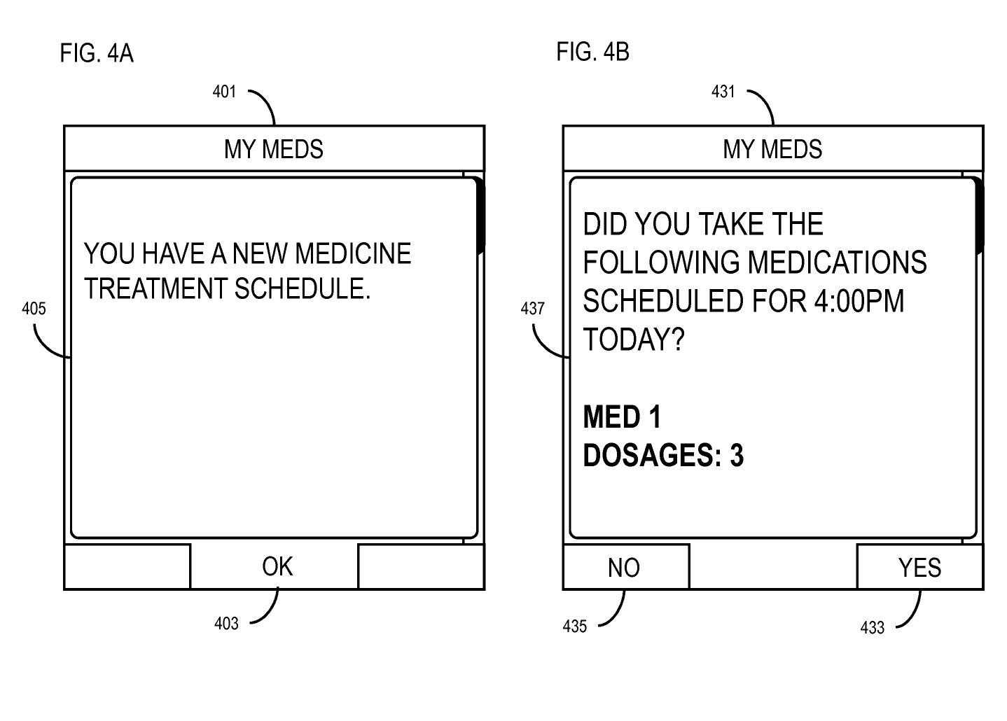

In step 307, as in certain embodiments, the control logic 205 determines to generate one or more notifications based, at least in part, on the schedule. As previously discussed, the one or more notifications may include reminders to take medication and/or to abide by a prescribed schedule. The one or more notifications may also include announcements, confirmations, queries, and/or the like. Some examples include messages that the patient has a new schedule as shown in FIG. 4A, that the patient has a new social network group as a result of the new schedule, that the patient has complied with the patient's prescribed schedule, etc. Another example may include a query comprising of one or more questions regarding whether the user/patient has followed the scheduled as prescribed. In other words, at least one of the one or more notifications may include a query regarding compliance with one or more items of the schedule.

In step 309, as in other embodiments, the control logic 205 determines to transmit the one or more notifications to the user, the one or more other users, or a combination thereof. Because the one or more notifications may include reminders, announcements, confirmations, queries, and/or the like, it may be important for the user/patient to receive such notifications for at least the purpose of monitoring the user/patient to adhere to prescribed regimens. Moreover, it may be equally important for the one or more other users to receive such notifications. As mentioned above, the patient may receive a query asking whether the patient has taken certain medications as scheduled. As such, the patient may indicate whether or not the medications have been taken. As a result, the patient's response or responses may cause an announcement to be transmitted to the one or more other users that the patient has either taken or not yet taken certain medications as scheduled. The one or more other users may thereafter, depending on the patient's response or responses to the query, send the patient messages reinforcing compliance with the patient's schedule or messages urging adherence to the patient's schedule. By way of example, messages that reinforce compliance may include statements such as “Congratulations! I knew you could do it!” and “Way to go!”, and messages that urge adherence may include statements such as “I just took my medication, you can take yours!” and “Come on! You and I need to stick to our schedules!” The reminders, announcements, confirmations, queries, and/or the like may be transmitted as part of the established communication sessions (e.g., text sessions, voice sessions, and/or video sessions). Thus, the one or more communication sessions may also relate, at least in part, to the notifications.

In step 311, the control logic 205 determines a treatment adherence rate based, at least in part, on one or more responses to the query. The adherence rate may also be determined based on one or more responses to one or more past queries. For example, the query may include one or more questions with regard to the medications that a patient is scheduled to take each day. As such, the adherence rate may be determined based on the patient's responses to the one or more questions for that day, that week, that month, that year, etc. If, for instance, the patient indicated that the patient has taken all the medications scheduled for that day, the adherence rate for that day would be 100%. On the other hand, if the patient has indicated in past queries that he has not taken certain medications as scheduled, the patient's adherence rate for that week, that month, that year, etc., may not be as high.

In step 313, the control logic 205 determines to generate a report of the treatment adherence rate, of other treatment adherence rates associated with the one or more other users, or a combination thereof. Subsequently, the report may be viewed by the user/patient and/or by the one or more other users via, for instance, their respective UE 101. As previously discussed, it may be important for patients to see a report of their own adherence rate. The report itself may also be a reminder that they should pay more attention, for instance, to their prescribed treatment regimen if the report indicates that their treatment adherence rate is not as high as it should be.

In addition, it may be equally important for the patient to see a report of the adherence rates of the one or more other users and/or for the one or more other users to see a report of the patient's adherence rate. For example, patients that see other users with a higher adherence rate may want to increase their own adherence rate, thereby being encouraged to abide by their prescribed regimens. In addition, reports that illustrate the adherence rates of others may also open the door for words of reinforcement or words of encouragement, depending on how a particular adherence rate may be viewed by others (e.g., high, sufficient, low, etc.). In other words, the reports are another incentive for the members of the social network group to communicate with each other and to encourage adherence to prescribe regimens. Similarly, reports that describes the treatment adherence rate of the social network group as a whole may also provide an incentive for the members to communicate with each other and to encourage adherence to prescribe regimens (e.g., a high group adherence rate may be viewed as a team effort).

FIGS. 4A-4B are diagrams of user interfaces providing notifications to a user, according to various embodiments. As discussed above, one or more notifications may be generated based on the schedule and, thereafter, transmitted to the user and/or to one or more other users. The notifications may comprise of announcements, confirmations, queries, and/or the like. As such, the notifications may include a query regarding compliance with one or more items of the schedule. FIG. 4A shows a user interface with a title bar 401, an option button 403, and a notification 405. As provided, the title bar 401 indicates that the user was in “MY MEDS” when the user received the notification 405 that the user has a new medicine treatment schedule. The user may then acknowledge receipt of the announcement, for instance, by clicking the option button 403 (e.g., “OK”).

FIG. 4B shows a user interface with a title bar 431, option buttons 433 and 435, and a notification 437. As provided, the title bar 431 indicates that the user was in “MY MEDS” when the user received the notification 437 comprising a query regarding compliance with one or more items of the schedule. The query, as shown in the diagram, asks the user whether the user has taken the particular listed medications as scheduled. The user may then state that the user has either taken or not taken the listed medications, for instance, by clicking either the option button 433 (e.g., “YES”) or the option button 435 (e.g., “NO”). By way of example, if “YES” is selected, a notification may be sent to other members of the social network group, indicating that the user has taken the medications. A notification may include messages such as “I have taken my medications!”, “I have done it again. You can too!”, etc., to encourage others to abide by their prescribed regimens. Moreover, the user interface may include access to messaging functions and/or applications. Thus, the user may also generate or supplement the messages by inputting text, taking images, capturing video, etc., either independently or as a result of selecting a particular option.

In addition, the user interface may include the use of widgets. In one embodiment, a widget may represent a particular treatment provided by a treatment provider. In one sample use case, the user interface may present the user with a “pill bottle” widget to represent medications that a doctor has prescribed for a particular treatment regimen. As such, the user interface may also display additional “pill bottle” widgets to the user as other treatment regimens are provided to the user by the doctor or other treatment providers. When the time comes to take the medications, the “pill bottle” widget may alert the user of such tasks. As a result, the user may be required, for instance, to drag-and-drop a pill from the “pill bottle” widget into a “user” widget (e.g., to represent taking the medications). Accordingly, the “user” widget may be used to gather information with regard to pills that the user has taken. After the pill has been placed into the “user” widget, a message may be sent to other members of the social network group. Thus, the “user” widget may have access to the messaging functions and/or applications. As mentioned, the user may also generate or supplement the message with text, images, video, etc., to encourage other members to take their medications as prescribed. In another embodiment, all treatments may be stored in one single widget, which may contain one or more treatment regimens. As such, the treatment regimens may access, independently or through a common interface of the widget, the messaging functions and/or applications.

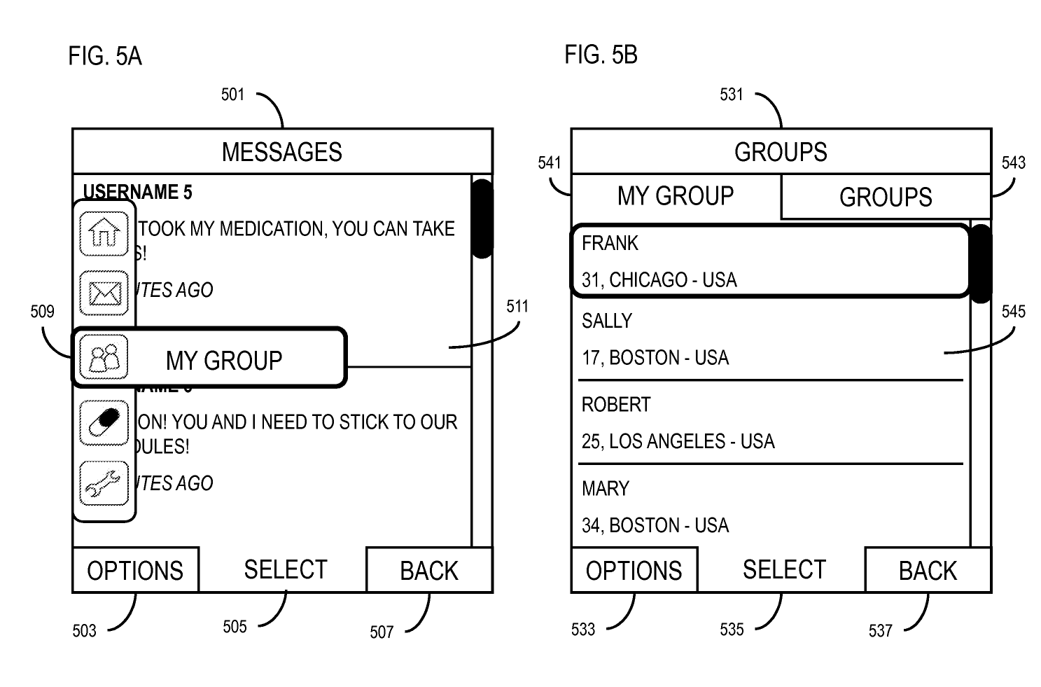

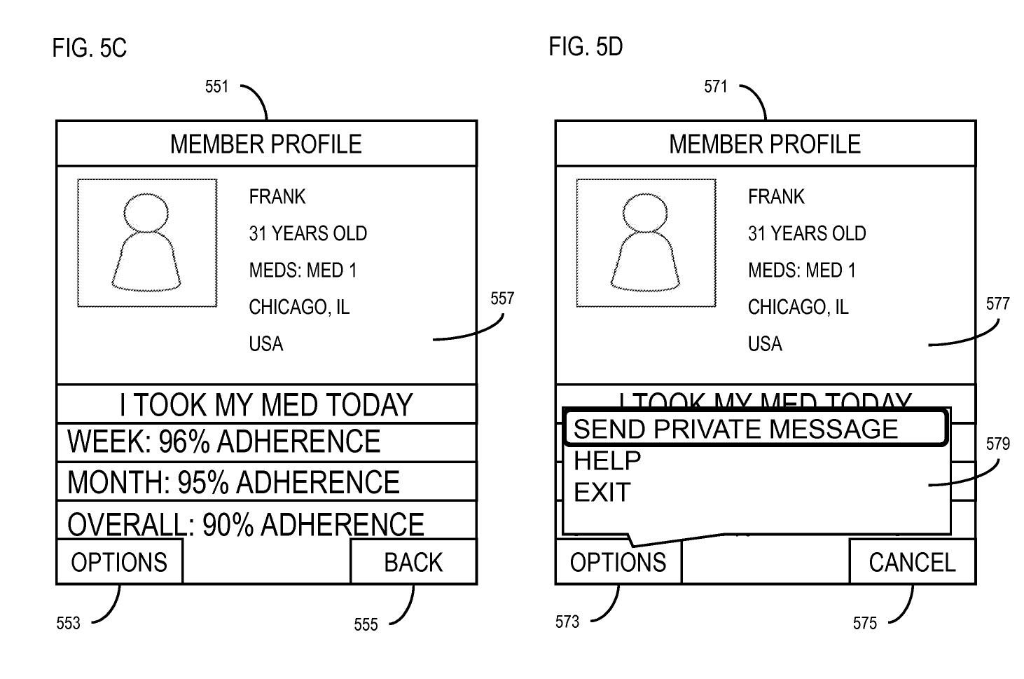

FIGS. 5A-5D are diagrams of user interfaces demonstrating the use of reports to encourage adherence to prescribed regimens, according to various embodiments. As previously mentioned, reports describing the treatment adherence rate of one or more members of a social network group may provide an incentive for the members to communicate with each other and to encourage adherence to prescribe regimens. FIG. 5A shows a user interface with a title bar 501, option buttons 503, 505, and 507, a menu bar 509, and a message area 511. As provided, the title bar 501 indicates that the user was in “MESSAGES” when the user activated the menu bar 509 (e.g., by touching a physical menu button (not shown) on the user device, tapping the left edge of the screen, etc.). The menu bar 509 comprises of several items, including a home button, a message button, a “MY GROUP” button, “MY MEDS” button, and a tools button. Behind the menu bar 509 is the message area 511, which displays at least two messages from one or more other users providing support and encouragement for the user to adhere, for instance, to prescribed treatment regimens. By way of example, the message area 511 may be a series of saved messages (SMS, email, etc.) and/or live conversations (chat rooms, instant messaging, etc.).

FIG. 5B shows a user interface with a title bar 531, option buttons 533, 535, and 537, tabs 541 and 543, and a members area 545. As provided, the title bar 531 indicates that the user is currently in “GROUPS” under the tab 541, “MY GROUP”, which may be accessed by the user by selecting the “MY GROUP” button as shown in FIG. 5A. The members area 545 displays the members of “MY GROUP” (e.g., the social network group associated with the user) and a short description for each member. In this example, some of the members of “MY GROUP” include Frank, Sally, Robert, and Mary.

FIG. 5C shows a user interface with a title bar 551, option buttons 553 and 555, and a profile area 557. As provided, the title bar 551 indicates that the user is currently in a “MEMBER PROFILE”, which may be accessed by the user by selecting one of the members listed in the members area 545 of FIG. 5B. Specifically, the user is currently viewing Frank's member profile. According to his profile, Frank is 31 years old, is scheduled to take “MED 1”, and currently lives in Chicago, Ill. in the USA. In addition, the member profile may display the member's treatment adherence rate. Here, Frank has taken his medication for the day. He also has an adherence rate of 96% for the week, 95% for the month, and 90% overall.

FIG. 5D shows a user interface with a title bar 571, option buttons 573 and 575, a profile area 577, and an options area 579. As provided, the title bar 571 indicates that the user is currently in a “MEMBER PROFILE”, which may be accessed by the user by selecting one of the members listed in the members area 545 of FIG. 5B. Specifically, the user is currently viewing Frank's member profile. After seeing that Frank has taken his medications for the day, the user may want to send Frank a message containing words of reinforcement. Similarly, the user may want to send Frank a message reinforcing his compliance with his schedule or a message urging adherence to his schedule, depending on how the user views Frank's treatment adherence rates (e.g., high, sufficient, low, etc.) for the week, for the month, and overall. As such, the option button 573, “OPTIONS”, has been selected. In response to the selection, one of the choices in the options area 579 that appears is to send a private message to Frank.

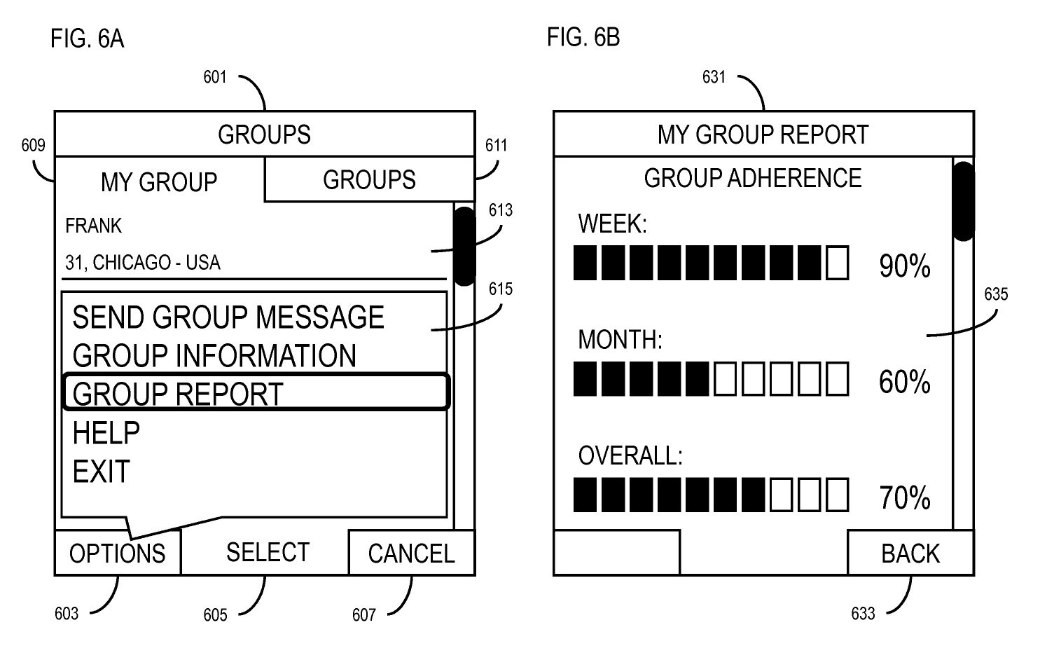

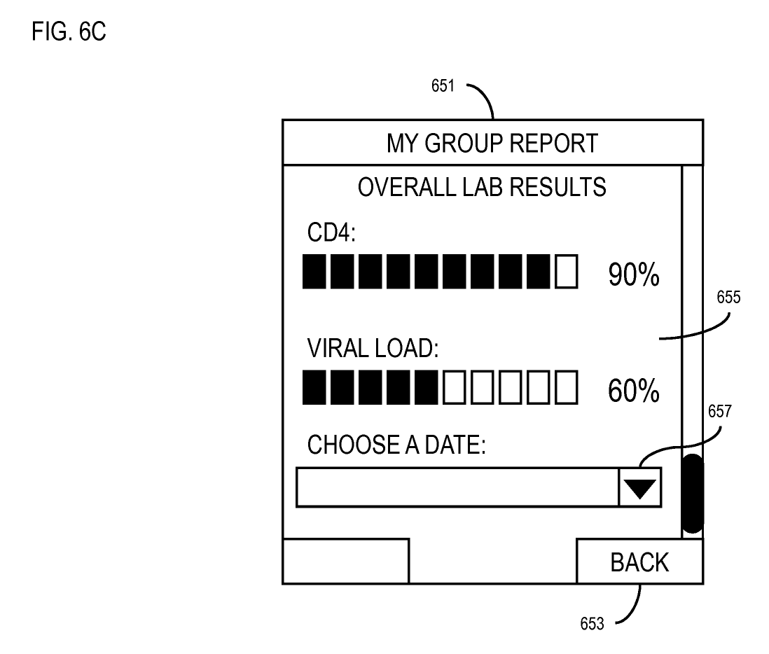

FIGS. 6A-6C are diagrams of user interfaces demonstrating the use of group reports to encourage group adherence to prescribed regimens, according to various embodiments. As previously mentioned, reports that describes the treatment adherence rate of a social network group as a whole may also provide an incentive for its members to communicate with each other and to encourage adherence to prescribe regimens (e.g., a high group adherence rate may be viewed as a team effort). FIG. 6A shows a user interface with a title bar 601, option buttons 603, 605, and 607, tabs 609 and 611, a members area 613, and an options area 615. As provided, the title bar 601 indicates that the user is currently in “GROUPS” under the tab 609, “MY GROUP”, which may be accessed by the user by selecting the “MY GROUP” button as shown in FIG. 5A. The members area 613 displays the members of “MY GROUP” (e.g., the social network group associated with the user) and a short description for each member. In this example, the option button 603, “OPTIONS”, has been selected. In response to the selection, the options area 615 appears and gives the user several choices, some of which include “SEND GROUP MESSAGE”, “GROUP INFORMATION”, and “GROUP REPORT”.

FIG. 6B shows a user interface with a title bar 631, an option button 633, and a report area 635. As provided, the title bar 631 indicates that the user is currently in “MY GROUP REPORT”, which may be accessed by the user by selecting “GROUP REPORT” in the options area 615 of FIG. 6A. The report area 635 displays the adherence rate of the user's social network group: 90% for the week, 60% for the month, and 70% overall. Similarly, FIG. 6C shows a user interface with a title bar 651, an option button 653, and a report area 655. In addition, the user interface provides a drop down menu 657. By way of example, the group report may also include recent or past lab results of the overall group. The particular lab results section of the report area 655 may be accessed by the user by scrolling down (e.g., using a physical page down button on user device (not shown), using the scrollbar on the right of the user interface (as displayed), etc.) from the view illustrated in FIG. 6B. In FIG. 6C, the most recent lab results are shown. If the user wishes to view past lab results, the user may, for instance, choose a date from the drop down menu 657 to view a particular past lab result.

As mentioned in the discussion of FIG. 6A, the options area 615 includes the choice of sending the group a message. After seeing the adherence rate and/or the overall lab results for the group, the user may want to send the group a message to reinforce or encourage members of the group to abide by their prescribed schedules. The nature of the message may depend on how the user views the adherence rate (e.g., high, sufficient, low, etc.) and/or the overall lab results for the group.

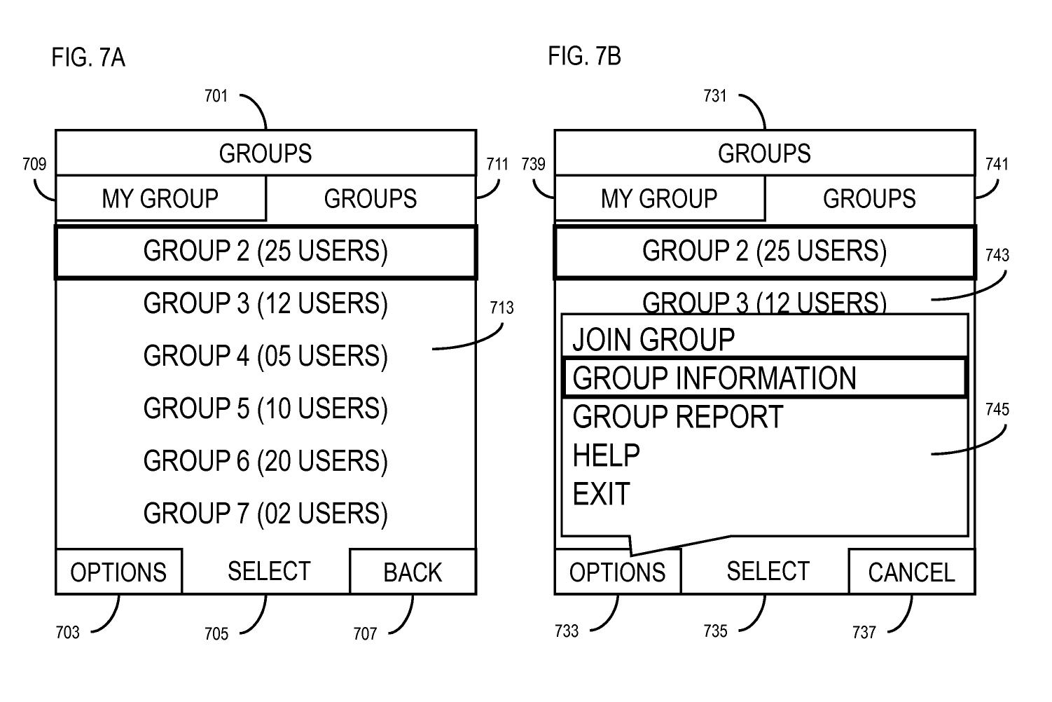

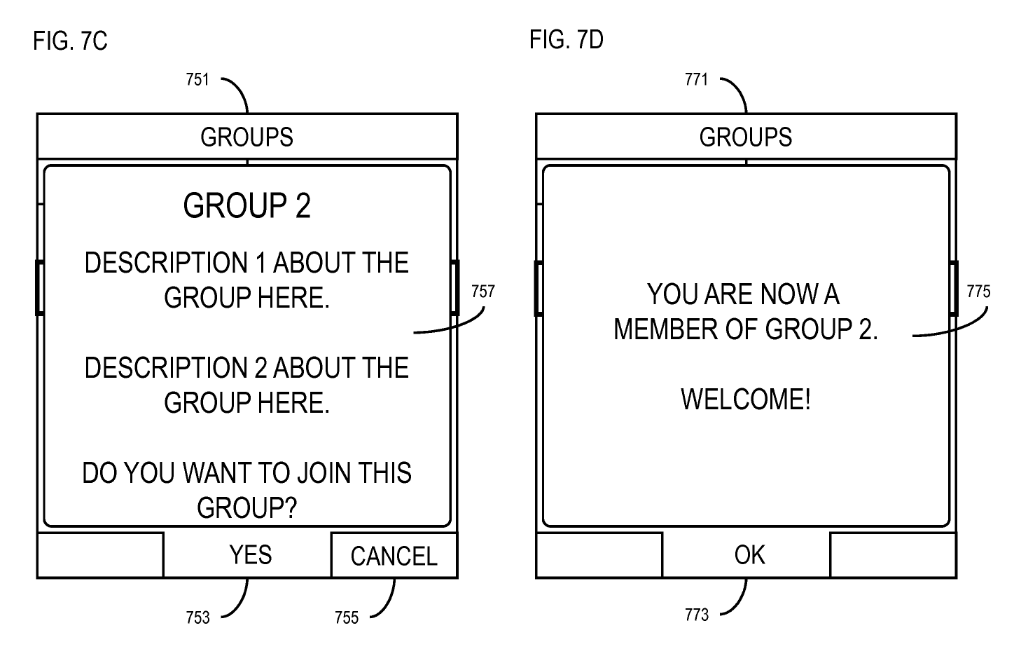

FIGS. 7A-7D are diagrams of user interfaces illustrating a process of joining a social network group, according to various embodiments. Although at least one social network group may be created for or assigned to the user, for instance, upon a schedule being specified for the user, the user may also have the option of selecting the social network groups that the user wishes to be associated with. FIG. 7A shows a user interface with a title bar 701, option buttons 703, 705, and 707, tabs 709 and 711, and a group list 713. As provided, the title bar 701 indicates that the user is currently in “GROUPS” under the tab 711, “GROUPS”. The group list 713 displays the groups available to the user. By way of example, the user may be limited to viewing and/or joining social network groups comprising of at least some members having schedules substantially similar to the user's schedule. Similarly, FIG. 7B shows a user interface with a title bar 731, option buttons 733, 735, and 737, tabs 739 and 741, and a group list 743. In addition, FIG. 7B depicts an options area 745 which appeared as a result of selecting the option button 733, “OPTIONS”. Some of the choices available on the options area 745 are “JOIN GROUP”, “GROUP INFORMATION”, and “GROUP REPORT”.

FIG. 7C shows a user interface with a title bar 751, option buttons 753, 755, and a description area 757. As provided, the title bar 701 indicates that the user is currently in “GROUPS”. The description area 757 displays information with regard to “GROUP 2”, which may be accessed by the user by selecting “GROUP INFORMATION” in the options area 745 of FIG. 7B. Moreover, the description area 757 solicits the user to join the group. Assuming that the user has the right permissions to join, the user may join the group, for instance, by clicking the option button 753 (e.g., “YES”). However, the user may also refuse the offer by clicking the option button 755 (e.g., “CANCEL”).

FIG. 7D shows a user interface with a title bar 771, an option button 773, and a notification 775. In this example, the user has received a confirmation of the user's membership into “GROUP 2” as a result joining the group. The user may have joined the group by clicking the option button 753 (e.g., “YES”) of FIG. 7C, by selecting “JOIN GROUP” in the options area 745 of FIG. 7B, or through any other available method of joining.

The processes described herein for monitoring adherence to prescribed regimens may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

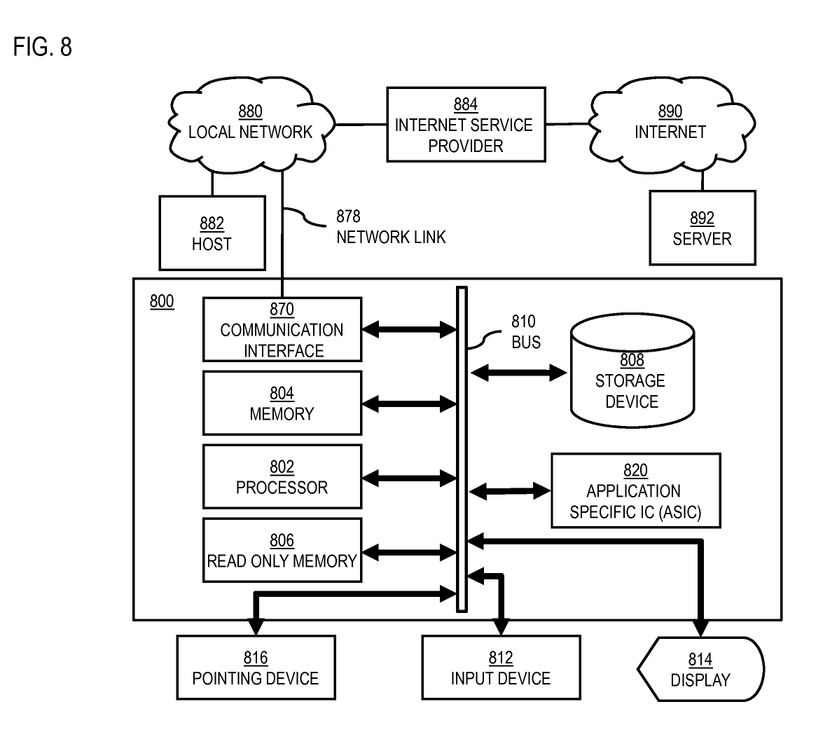

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to monitoring adherence to prescribed regimens as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of monitoring adherence to prescribed regimens.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to monitoring adherence to prescribed regimens. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for monitoring adherence to prescribed regimens. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for monitoring adherence to prescribed regimens, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for monitoring adherence to prescribed regimens.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to monitor adherence to prescribed regimens as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of monitoring adherence to prescribed regimens.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to monitor adherence to prescribed regimens. The memory 905 also stores the data associated with or generated by the execution of the inventive steps.

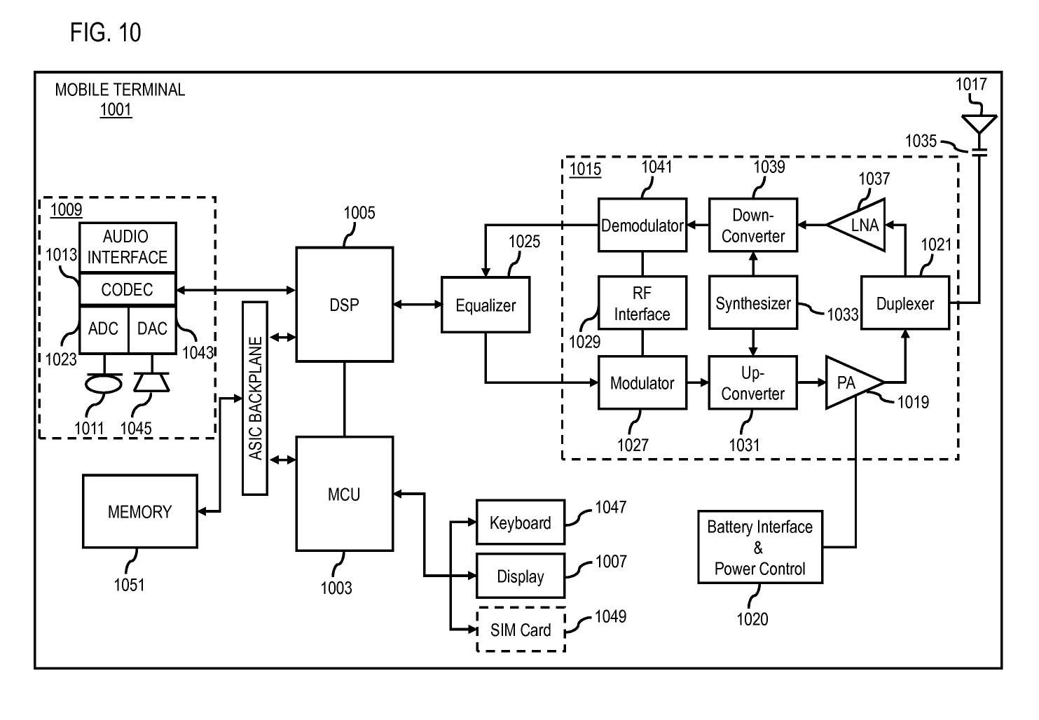

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of monitoring adherence to prescribed regimens. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of monitoring adherence to prescribed regimens. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to monitor adherence to prescribed regimens. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving an input for specifying a schedule associated with a user;
determining to create at least one social network group, the members of the social network group including, at least in part, the user and one or more other users; and
determining to establish one or more communication sessions among devices corresponding to at least some of the members based, at least in part, on the schedule.

2. A method of claim 1, further comprising:
determining to generate one or more notifications based, at least in part, on the schedule; and
determining to transmit the one or more notifications to the user, the one or more other users, or a combination thereof,
wherein the one or more communication sessions relate, at least in part, to the notifications.

3. A method of claim 2, wherein at least one of the one or more notifications includes a query regarding compliance with one or more items of the schedule.

4. A method of claim 3, further comprising:
determining a treatment adherence rate based, at least in part, on one or more responses to the query.

5. A method of claim 4, further comprising:
determining to generate a report of the treatment adherence rate, of other treatment adherence rates associated with the one or more other users, or a combination thereof.

6. A method of claim 1, wherein the schedule is associated with a treatment regimen.

7. A method of claim 1, further comprising:
determining to trigger one or more actions associated with the schedule,
wherein the one or more actions include, at least in part, initiating communication with a treatment provider, scheduling an appointment with a treatment provider, initiating one or more transactions to obtain one or more treatment items, or a combination thereof.

8. A method of claim 1, further comprising:
determining to parse the one or more communication sessions; and
determining information related to the schedule, a condition of the user, respective conditions of the one or more other users, or a combination thereof.

9. A method of claim 1, further comprising:
determining to select at least some of the one or more other users based, at least in part, on whether the at least some of the one or more other users have respective other schedules that are substantially similar to the schedule.

10. A method of claim 1, wherein the one or more other users include one or more treatment providers.

11. An apparatus comprising:
at least one processor; and
at least one memory including computer program code for one or more programs,
the at least one memory and the computer program code configured to, with the at least one processor, cause the apparatus to perform at least the following,
receive an input for specifying a schedule associated with a user,
determine to create at least one social network group, the members of the social network group including, at least in part, the user and one or more other users, and
determine to establish one or more communication sessions among devices corresponding to at least some of the members based, at least in part, on the schedule.

12. An apparatus of claim 11, wherein the apparatus is further caused to:
determine to generate one or more notifications based, at least in part, on the schedule; and
determine to transmit the one or more notifications to the user, the one or more other users, or a combination thereof,
wherein the one or more communication sessions relate, at least in part, to the notifications.

13. An apparatus of claim 12, wherein at least one of the one or more notifications includes a query regarding compliance with one or more items of the schedule.

14. An apparatus of claim 13, wherein the apparatus is further caused to:
determining a treatment adherence rate based, at least in part, on one or more responses to the query.

15. An apparatus of claim 14, wherein the apparatus is further caused to:
determining to generate a report of the treatment adherence rate, of other treatment adherence rates associated with the one or more other users, or a combination thereof.

16. An apparatus of claim 11, wherein the schedule is associated with a treatment regimen.

17. An apparatus of claim 11, wherein the apparatus is further caused to:
determining to trigger one or more actions associated with the schedule,
wherein the one or more actions include, at least in part, initiating communication with a treatment provider, scheduling an appointment with a treatment provider, initiating one or more transactions to obtain one or more treatment items, or a combination thereof.

18. An apparatus of claim 11, wherein the apparatus is further caused to:
determining to parse the one or more communication sessions; and
determining information related to the schedule, a condition of the user, respective conditions of the one or more other users, or a combination thereof.

19. An apparatus of claim 11, wherein the apparatus is further caused to:
determining to select at least some of the one or more other users based, at least in part, on whether the at least some of the one or more other users have respective other schedules that are substantially similar to the schedule.

20. An apparatus of claim 11, wherein the one or more other users include one or more treatment providers.
